(19) United States
(12) Patent Application Publication
(10) Pub. No.: US 2018/0218852 A1
(43) Pub. Date: Aug. 2, 2018

(54) ELECTRICAL SERVICE SWITCHING DEVICE HAVING AN EXHAUST AIR OPENING

(71) Applicant: ABB Schweiz AG, Baden (CH)

(72) Inventors: Ralf Weber, Heidelberg (DE); Erwin Muders, Heidelberg (DE); Klaus-Peter Eppe, Waldbrunn (DE)

(21) Appl. No.: 15/881,836

(22) Filed: Jan. 29, 2018

(30) Foreign Application Priority Data
Jan. 30, 2017 (DE) 10 2017 101 723.2

(51) Int. Cl. H01H 9/34

(52) U.S. Cl. CPC H01H 9/342

(57) ABSTRACT

An electrical service switching device includes: a housing in which at least one contact point is arranged, the housing having a first terminal connection area, in which a plug-in terminal is arranged and is configured for for the purpose of connecting the service switching device to a busbar, and a second terminal connection area, in which a screw terminal for the connection of connection conductors is arranged, the first and the second terminal connection area being formed on opposite narrow sides of the housing; and an arc quenching device associated with the at least one contact point and having an arc inlet side and an exhaust air side at which an exhaust air flow can exit. The exhaust air side of the arc quenching device is oriented towards the first terminal connection area in the housing interior.

### CROSS-REFERENCE TO PRIOR APPLICATION

Priority is claimed to German Patent Application No. DE 10 2017 101 723.2, filed on Jan. 30, 2017, the entire disclosure of which is hereby incorporated by reference herein.

### FIELD

The invention relates to an electrical service switching device, having a housing in which at least one contact point is arranged and having an arc quenching device which is associated with the contact point and has an arc inlet side and an exhaust air side at which an exhaust air flow can exit, wherein the housing has a first terminal connection area, in which a plug-in terminal is arranged for the purpose of connecting the service switching device to a busbar, and a second terminal connection area, in which a screw terminal for the connection of connection conductors is arranged, wherein the first and the second terminal connection area are formed on opposite narrow sides of the housing.

### BACKGROUND

A service switching device of this kind is, for example, a line circuit breaker or a motor circuit breaker or a residual-current circuit breaker. As is known, a line circuit breaker serves to be incorporated in an electrical circuit and either to be able to interrupt and reconnect the electrical circuit by manual switching or to be able to automatically interrupt the electrical circuit as a protective measure in the event of a short-circuit current for example. To this end, the line circuit breaker has at least a first and a second connection terminal between which a current path is routed in the interior of the line circuit breaker and through the said line circuit breaker. A plurality of line circuit breakers are often arranged in a switchgear cabinet in a manner lined up next to one another, sometimes together with other service switching devices such as residual-current circuit breakers, timing relays or auxiliary switches. In order to simplify installation, lined-up line circuit breakers receive the current in parallel in a manner supplied by means of a so-called busbar. To this end, provision is sometimes made in the prior art for the corresponding first connection terminal of the service switching device, also called the feed terminal or else the line terminal, to be designed as a plug-in terminal with which the device is plug-mounted onto the busbar and is mechanically held and electrically connected in this way. The connection conductors which lead to the respective downstream electrical circuit which is intended to be protected and switched by the line circuit breaker are connected to the second connection terminal, also called the outgoing terminal. In the prior art, screw terminals are usually provided on the outgoing side for this purpose. A terminal configuration of this kind is shown, for example, in a device illustrated in U.S. Pat. No. 6,803,535B1.

The current path leads, in the interior of the line circuit breaker, via a contact point which is formed with a fixed contact piece and a moving contact piece which is fitted to a usually pivotably mounted contact lever. The contact lever can be pivoted from a connected position to a disconnected position, wherein said contact lever passes through a clearly discernible pivoting angle, often of the order of magnitude of at least 90°, between the connected position and the disconnected position. The moving contact piece is moved away from the stationary contact piece by corresponding pivoting of the contact lever out of the connected position to the disconnected position, the contact point being opened and the current path being interrupted as a result. The contact lever can be pivoted manually. To this end, the line circuit breaker has, on its front side which is accessible for manual operation when the device is installed, for example, in a service distribution block, a switching toggle which is pivotably mounted on the housing and has a switching handle. The switching toggle is mechanically operatively connected to the contact lever in order to pivot the said contact lever. Furthermore, the line circuit breaker has at least one first tripping element which is likewise mechanically operatively connected to the contact lever and, in the event of a short-circuit current, acts on the contact lever and pushes the said contact lever away from the stationary contact piece, so that a contact is opened as quickly as possible in the event of a short circuit. This first tripping element is often a magnetic tripping device with a core, an armature, a restraint spring and a striking pin. The current flows through a tripping coil, the magnetic field of the said tripping coil very quickly becoming so large in the event of a short circuit that it pushes the moving armature outwards against the restoring force of the restraint spring, and the striking pin which is coupled to the armature then strikes the contact point. There is also the variant that, in the event of a short circuit, the two contact pieces move away from one another owing to an electrodynamic repulsion force, without a magnetic impact armature system being required for this purpose. In this case, the contact point itself forms the tripping element to a certain extent. An electrodynamic repulsion force between the two contact pieces often assists the effect of the magnetic impact armature system. Furthermore, a line circuit breaker often also has a second tripping element which is likewise mechanically operatively connected to the contact lever and which is designed to likewise act on the contact lever and push the said contact lever away from the stationary contact piece in the event of an overcurrent which arises over a relatively long period of time, that is to say a current in the current path with a current intensity which is clearly above the nominal current intensity for which the device is designed but which is still considerably lower than a short-circuit current, in order to prevent thermal overloading of the device. The various mechanical operative connections are usually realized by means of a mechanical switching mechanism. Different constructions and embodiments of switching mechanisms and the respective mechanical operative connections thereof between switching levers, contact levers and tripping elements are already known for this purpose. An example of this is shown in US 20120250206 A1. A frequent customer requirement is also that there is an indication for a user on the front side of the line circuit breaker when short-circuit tripping has taken place and the contact point has been interrupted owing to this short-circuit tripping. In this case, the switching mechanism has a so-called trip position function which ensures that the switching toggle does not pivot into the normal disconnected position in the event of short-circuit tripping, but rather remains in a central position between the connected position and the disconnected position, it then being easy to identify from the outside that short-circuit tripping has taken place. A tripped indicator apparatus is then often also provided, for example a coloured indicator area which is moved to a viewing window, which is accordingly provided in the housing front side, in the event of short-circuit tripping for the purpose of additionally visually indicating short-circuit tripping. The movement of the indicator area is also controlled by the switching mechanism, a likewise mechanical operative connection between this indicator area and the switching mechanism being provided for this purpose.

In the event of a short circuit-related tripping process or manual disconnection under load, the air between the two contact pieces is ionized and an arc is produced between the two contact pieces which are isolated from one another here, the said arc possibly leading to damage to or destruction of the said contact pieces and to thermal damage to the line circuit breaker if it is active for a relatively long time. The switching arc is normally extinguished only when its impedance has become so large that current can no longer flow. The impedance of the arc increases, for example, as the length of said arc increases. However, there is not enough space in a compact line circuit breaker in order to draw the resulting arc to such an extent that it would be necessary to extinguish the said arc. An arc quenching device as is likewise illustrated in US 20120250206 A1 is often provided in the prior art for this reason. The arc quenching device is formed by an arc splitter stack with splitter plates which are stacked parallel in relation to one another. The arc is fed to the arc inlet side of the arc splitter stack by means of arc guide rails. In the arc splitter stack, the arc is divided into a number of arc elements which are connected electrically in series, one arc element usually being produced between two adjacent splitter plates in each case. Splitting the arc into a series of arc elements which are positioned in series increases the arc impedance in a narrow space, so that, when the arc moves within the arc splitter stack, the arc is extinguished after a short time. The ionized gases which are produced during the burning time of the arc, also called exhaust air, create a high pressure in the arc quenching device. In order to reduce this high pressure, the arc splitter stack is provided with openings on its side which is situated opposite the arc inlet side, it being possible for the exhaust air to leave the splitter stack through the said openings, this side therefore also being called the exhaust air side of the arc quenching device. The site at which the arc is produced is usually located outside the splitter stack in a so-called prechamber. The contact point is arranged there. From there, so-called arc guide plates lead to the arc quenching chamber. The arc base points move from the contact pieces to the arc guide plates and then move along these to the arc inlet side of the arc quenching device. The prechamber is often covered with so-called prechamber panels in order to physically delimit the said prechamber from the housing walls and to protect the housing walls in the region of the prechamber. The prechamber panels can additionally have an insert which is composed of metal or of a ferromagnetic material and assists and accelerates the movement speed of the arc in the direction of the arc splitter stack.

In the prior art, the exhaust air side of the arc quenching chamber is usually open to the interior of the device. There is often also an exhaust air opening in the housing rear wall close to the exhaust air side, it being possible for the exhaust air to flow outwards into the installation area surrounding the line circuit breaker at its rear side through the said exhaust air opening. If a plurality of line circuit breakers are connected to one or more busbars in a service distribution board, there is a risk that, when the exhaust air exits at the housing rear side, it propagates in the direction of the busbars and causes short circuits between the busbars since the exhaust air gases are still electrically conductive.

WO 95/20237 proposes a device in which the exhaust air is guided in exhaust air chambers in the interior of the device and is prevented from leaving the device. However, in the case of multiple short-circuit switching operations with correspondingly high quantities of exhaust air, this can lead to either the exhaust air leaving deposits on current-carrying components in the interior of the device and thereby leading to short circuits in the device interior, or to a high overpressure in the exhaust air chamber with the risk of the device housing rupturing.

### SUMMARY

In an embodiment, the present invention provides an electrical service switching device, comprising: a housing in which at least one contact point is arranged, the housing having a first terminal connection area, in which a plug-in terminal is arranged and is configured for connecting the service switching device to a busbar, and a second terminal connection area, in which a screw terminal for the connection of connection conductors is arranged, the first and the second terminal connection area being formed on opposite narrow sides of the housing; and an arc quenching device associated with the at least one contact point and having an arc inlet side and an exhaust air side at which an exhaust air flow can exit, wherein the exhaust air side of the arc quenching device is oriented towards the first terminal connection area in the housing interior, wherein the housing has an exhaust air opening via which the exhaust air flow leaves the housing, and wherein the exhaust air opening is fitted to a narrow side of the housing, which narrow side is situated opposite the first terminal connection area.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an internal view into a service switching device according to the invention from which the upper housing half-shell has been removed,

FIG. 2 shows a view of a detail of the housing in the region of the exhaust air opening,

FIG. 3 is a schematic illustration of the internal view into a service switching device according to the invention, and

FIG. 4 is a schematic illustration of two service switching devices according to the invention, installed in series in a service distribution board.

### DETAILED DESCRIPTION

According to an embodiment of the invention, the exhaust air side of the arc quenching device is oriented towards the first terminal connection area in the housing interior, and the housing has an exhaust air opening via which the exhaust air flow leaves the housing, and the exhaust air opening is fitted to a narrow side of the housing, which narrow side is situated opposite the first terminal connection area. As a result, the exhaust air can leave the housing on that side which is averted from the busbar, so that flashovers cannot occur in the region of the busbar when the line circuit breaker is installed in a distribution box with busbars.

According to one advantageous embodiment, the exhaust air side issues into a blowout channel which leads the exhaust air flow past the plug-in terminal and the screw terminal to the exhaust air opening. As a result, the exhaust air can no longer come into contact with voltage-carrying components in the interior of the housing either, the said exhaust air being kept away from the assemblies and components arranged in the interior of the housing, such as the tripping elements, the connecting current conductors and wires, the contact points and the switching mechanism for example, by the exhaust air channel.

According to one advantageous embodiment, the exhaust air channel is formed with guide walls which are integrally formed on the housing wall.

According to one advantageous embodiment, the arc quenching device is formed with an arc splitter stack with splitter plates which are stacked parallel in relation to one another.

According to one advantageous embodiment, the arc quenching device has, on the exhaust air side, a closure wall with ventilation openings, so that one of the guide walls is at least partially formed by the closure wall in the upstream part of the exhaust air channel.

In the figures, identical or identically acting assemblies or components are provided with the same reference symbols.

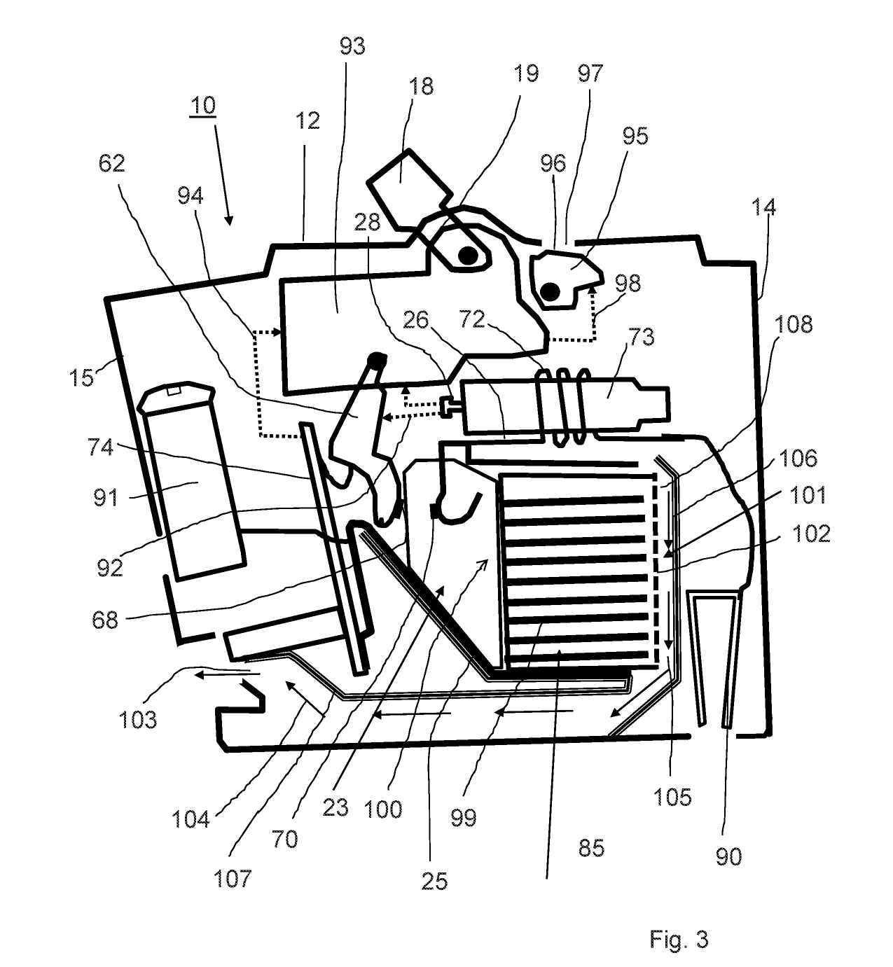

FIG. 3 will now be considered first of all.

FIG. 3 shows a schematic and exemplary internal view into a line circuit breaker 10 from which one housing half-shell has been removed. The line circuit breaker 10 has a first connection terminal 90 and a second connection terminal 91 between which a current path is routed in the interior of the line circuit breaker 10 and through the said line circuit breaker. The first connection terminal 90, also called the feed terminal or else the line terminal, is designed as a plug-in terminal with which the device can be plug-mounted, for example, onto a busbar, not illustrated here, and is mechanically held and electrically connected in this way. The connection conductors which lead to the respective downstream electrical circuit which is intended to be protected and switched by the line circuit breaker 10 are connected to the second connection terminal 91, also called the outgoing terminal, not illustrated here. The outgoing terminal 91 is in the form of a screw terminal.

The current path is routed, in the interior of the line circuit breaker 10, via a contact point which is formed with a fixed contact piece 70 and a moving contact piece 68 which is fitted to a pivotably mounted contact lever 62. The contact lever 62 can be pivoted from a connected position to a disconnected position. The moving contact piece 68 is moved away from the stationary contact piece 70 by corresponding pivoting of the contact lever 62 out of the connected position to the disconnected position, the contact point being opened and the current path being interrupted as a result. The contact lever 62 can be pivoted manually. To this end, the line circuit breaker 10 has, on its front side 12 which is accessible for manual operation when the device is installed, for example, in a service distribution board, a switching toggle 19 which is pivotably mounted on the housing and has a switching handle 18. The switching toggle 19 is mechanically operatively connected to the contact lever 62 in order to pivot the said contact lever. Furthermore, the line circuit breaker 10 has at least one first tripping element 73 which is likewise mechanically operatively connected to the contact lever 62 and, in the event of a short-circuit current, acts on the contact lever 62 and pushes the said contact lever away from the stationary contact piece 70, so that a contact is opened as quickly as possible in the event of a short circuit. This first tripping element 73 is a magnetic tripping device with a core (not depicted), an armature, a restraint spring (not depicted) and a striking pin 28. The current flows through a tripping coil 72, the magnetic field of said tripping coil very quickly becoming so large in the event of a short circuit that it pushes the moving armature outwards against the restoring force of the restraint spring, and the striking pin 28 which is coupled to the armature then strikes the contact point. This is schematically indicated in FIG. 3 by a dashed first operative connection line 92. The line circuit breaker 10 also has a second tripping element 74 which is likewise mechanically operatively connected to the contact lever 62 and which is designed to likewise act on the contact lever 62 and move the said contact lever away from the stationary contact piece 70 in the event of an overcurrent which arises over a relatively long period of time, that is to say a current in the current path with a current intensity which is above the nominal current intensity for which the device is designed but which is still considerably lower than a short-circuit current, in order to prevent thermal overloading of the device. The various mechanical operative connections are realized using a mechanical switching mechanism 93. In the case of the thermal tripping element 74, here a thermal bimetallic strip, a mechanical operative connection is made along a second operative connection line 94 to the switching mechanism 93, and the switching mechanism 93 pivots the switching lever 62. The switching toggle 19 is also operatively coupled to the switching mechanism 93. Pivoting of the switching toggle 19 causes a change in the switching state of the switching mechanism and therefore pivoting of the switching lever 62.

The switching mechanism 93 also has a so-called trip position function which ensures that the switching toggle 19 does not pivot into the normal disconnected position in the event of short-circuit tripping, but rather remains in a central position between the connected position and the disconnected position, it then being easy to identify from the outside that short-circuit tripping has taken place. Furthermore, a tripped indicator apparatus 95 is also provided, for example a coloured indicator area on the visible side of a pivotable lever, which coloured indicator area is moved to a viewing window 97, which is accordingly provided in the housing front side 12, in the event of short-circuit tripping for the purpose of additionally visually indicating short-circuit tripping. The movement of the indicator area 96 is also controlled by the switching mechanism 93, a likewise mechanical operative connection between this indicator area 96 and the switching mechanism 93, schematically illustrated by the dashed third operative connection line 98 here, being provided for this purpose.

In the event of a short circuit-related tripping process or manual disconnection under load, the air between the two contact pieces 68, 70 is ionized and an arc is produced between the two contact pieces 68, 70 which are isolated from one another here, the said arc possibly leading to damage to or destruction of the said contact pieces and to thermal damage to the line circuit breaker 10 if it is active for a relatively long time. The switching arc is normally extinguished only when its impedance has become so large that current can no longer flow. The impedance of the arc increases, for example, as the length of said arc increases. However, there is not enough space in a compact line circuit breaker 10 in order to draw the resulting arc to such an extent that it would be necessary to extinguish the said arc. An arc quenching device 85 is provided for this reason. The arc quenching device 85 is formed by an arc splitter stack 99 with splitter plates which are stacked parallel in relation to one another. The arc is fed to the arc inlet side 100 of the arc splitter stack 99 by means of arc guide rails 25, 26. In the arc splitter stack 99, the arc is divided into a number of arc elements which are electrically in series, one arc element usually being produced between two adjacent splitter plates in each case. Splitting the arc into a series of arc elements which are positioned in series increases the arc impedance in a narrow space, so that, when the arc moves within the arc splitter stack 99, the arc is extinguished after a short time. The ionized gases which are produced during the burning time of the arc, also called exhaust air, create a high pressure. In order to reduce this high pressure, the arc splitter stack 99 is provided with openings 102 on its side 101 which is situated opposite the arc inlet side 100, it being possible for the exhaust air to leave the splitter stack 99 through the said openings, this side therefore also being called the exhaust air side 101 of the arc quenching device 99. The site at which the arc is produced is located outside the splitter stack 99 in the prechamber area 23. The contact point is arranged there. From there, the arc guide rails 25, 26 lead to the arc quenching chamber 99. The arc base points move from the contact pieces 68, 70 to the arc guide plates 25, 26 and then move along these to the arc inlet side 100 of the arc quenching device 99. The prechamber area 23 is covered with prechamber panels 24—only one of these panels is illustrated here—in order to physically delimit the said prechamber from the housing walls and to protect the housing walls in the region of the prechamber area 23. The prechamber panels 24 can additionally have an insert which is composed of metal or of a ferromagnetic material and assists and accelerates the movement speed of the arc in the direction of the arc splitter stack.

The exhaust air side 101 of the arc quenching device 99 is oriented towards the first terminal connection area, in which the first connection terminal 90, the plug-in terminal, is arranged, in the housing interior. The housing has an exhaust air opening 103 via which the exhaust air flow, symbolically illustrated by arrows 104, leaves the housing. The exhaust air opening 103 is fitted to the narrow side 15 of the housing, which narrow side is situated opposite the first terminal connection area in which the first connection terminal 90, the plug-in terminal, is arranged. As a result, the exhaust air can leave the housing on that side which is averted from the busbar when the line circuit breaker 10 is plug-mounted onto a busbar by way of the plug-in terminal 90, so that flashovers cannot occur in the region of the busbar when the line circuit breaker 10 is installed in a distribution box with busbars.

The exhaust air side 101 of the splitter stack 99 issues into a blowout channel 105 which leads the exhaust air flow 104 past the plug-in terminal 90 and the screw terminal 91 to the exhaust air opening 103. As a result, the exhaust air 104 can no longer come into contact with voltage-carrying components in the interior of the housing either, the said exhaust air being kept away from the assemblies and components arranged in the interior of the housing, such as the tripping members 73, 74, the connecting current conductors and wires, the contact point and the switching mechanism 93 for example, by the blowout channel 105.

The blowout channel 105 is formed with guide walls 106, 107 which are integrally formed on the housing wall.

The arc quenching device 99 has, on the exhaust air side, a closure wall 108 with ventilation openings 102, so that one of the guide walls is at least partially formed by the closure wall 108 in the upstream part 108 of the blowout channel 105.

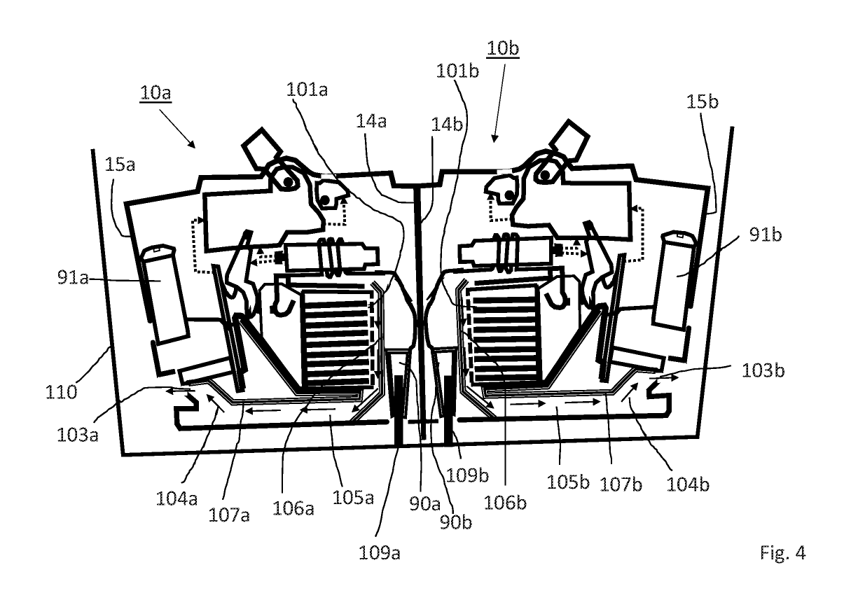

FIG. 4 will now be considered. The said figure is an exemplary schematic illustration of how two line circuit breakers 10a and 10b, each of which is constructed as illustrated and described in FIG. 3, are arranged in a service distribution board 110. If the elements and components in FIG. 4 are provided with reference symbols, these reference symbols correspond to those illustrated and described in FIG. 3, but in each case with the addition of the lowercase letter a for components of the line circuit breaker 10a and the lowercase letter b for components of the line circuit breaker 10b. The two line circuit breakers 10a and 10b are arranged in series, wherein they bear against each other by way of that side wall 14a, 14b in the vicinity of which the respective plug-in terminal 90a, 90b is arranged within the respective line circuit breaker 10a, 10b. The two busbars 109a, 109b are also schematically illustrated in FIG. 4, the two line circuit breakers 10a, 10b being plug-mounted onto the said busbars by way of their respective plug-in terminal 90a, 90b.

The advantage of the design of the line circuit breaker according to the present invention is clear in the illustration of FIG. 4. The two busbars 109a and 109b are located in the central part of the service distribution board 110. Therefore, the two plug-in terminals 90a and 90b of the two line circuit breakers 10a and 10b are also located in the central part of the service distribution board 110. The exhaust air side 101a of the line circuit breaker 10a points to the right, in the direction of the busbars 109a, 109b. The exhaust air side 101b of the line circuit breaker 10b points to the left, likewise in the direction of the busbars 109b. The exhaust air flow 104a of the line circuit breaker 10a is guided away from the plug-in terminal 90a and therefore from the first busbar 109a to the exhaust air opening 103a which is situated on the narrow side 15a which is averted from the busbar 109a, that is to say to outside the service distribution board 110, by the blowout channel 105a which is formed by the guide walls 106a, 107a. The exhaust air flow 104b of the line circuit breaker 10b is guided away from the plug-in terminal 90b and therefore from the first busbar 109b to the exhaust air opening 103b which is situated on the narrow side 15b which is averted from the busbar 109b, that is to say likewise to outside the service distribution board 110, by the blowout channel 105b which is formed by the guide walls 106b, 107b. The two exhaust air flows 104a, 104b therefore each pass out of the line circuit breakers 10a, 10b and into the interior of the service distribution board 110 at a great distance from the busbars 109a, 109b, and therefore cannot have an adverse effect in the region of the busbars 109a, 109b. In particular, the risk of conductive particles from the exhaust air flows being deposited on the guide rails or on housing parts in the region of the guide rails is reduced, as is the risk of flashovers and short circuits being able to form owing to the ionized exhaust air in the region of the busbars 109a, 109b.

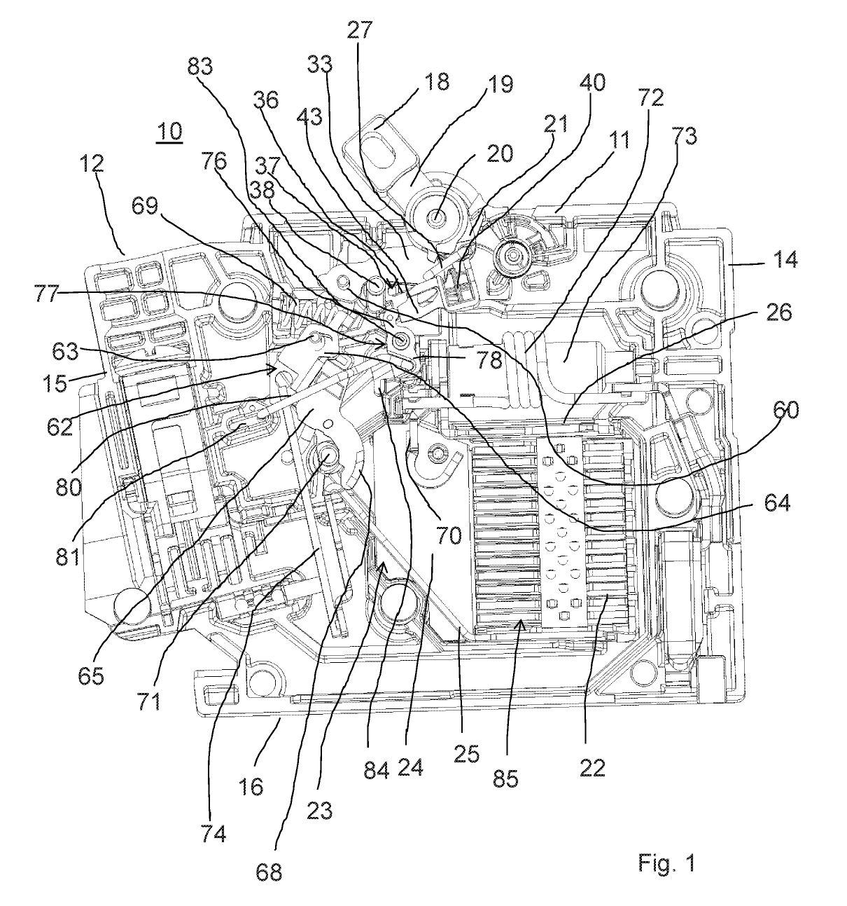

Reference will now be made to FIG. 1.

The said figure shows a structural embodiment of the line circuit breaker 10 illustrated merely schematically and by way of example in FIG. 3. Details relating to the switching mechanism and the function of the said switching mechanism in particular are intended to be explained with reference to FIG. 1. The line circuit breaker 10 has a housing which is composed of two housing half-shells, only the first housing half-shell 11 of which is partially illustrated. This housing half-shell 11 has, like the supplementary second housing half-shell, not illustrated, a front wall 12 and side walls 14, 15, and also a fastening side 16 and broad sides which are not visible in the illustration of FIG. 1.

An opening, through which the switching handle 18 of a switching toggle 19 protrudes, is located in the front wall 12. The switching toggle 19 has a rotation axis. Two fork-like projections, of which only one projection 21 is visible in the illustration of FIG. 1, are located on the side which is situated diametrically opposite the switching handle 18. The two projections leave a receiving space, which is open on one side, free between them. Each of the two projections has an eye-like opening at its end which is averted from the switching handle 18. The longitudinal centre axis of the switching handle 18 runs through the centre point of the eye-like openings.

A Limb of a U-shaped clip 27 engages into each of the eye-like openings.

The clip web of the clip 27, which clip web connects the two U-limbs, engages into two latching openings in an intermediate lever 33. To this end, the intermediate lever 33 has, at one end, a U-profile which ends in two fork-like projections, wherein each of the two fork-like projections has a respective latching opening at the end.

At the same time, the clip web engages into an elongate hole 36 in a catch lever 37 which is arranged beneath the intermediate lever 33 and runs partially in the U-profile recess between the two end projections of the intermediate lever 33 and extends through the said catch lever. Therefore, the U-shaped clip 27 is guided, by way of its clip web, in the elongate hole 36 in the catch lever 37, and at the same time the intermediate lever 33 is connected in an articulated manner to the clip web by way of its latching openings. The switching toggle 19, the intermediate lever 33 and the catch lever 37 therefore form a unit by being coupled to one another by the clip 27.

A peg 38 is respectively integrally formed on the two sides of the catch lever 37, by means of which pins the catch lever 37 is mounted, in a fixed position and such that it can rotate, in both housing half-shells in the case of a two-shell housing, or in the housing shell and the cover in the case of a single-shell housing with a cover.

The direction of longitudinal extent of the intermediate lever 33, of the catch lever 37 and of the limbs of the clip 27 run parallel to the broad face of the device housing.

A tripping lever 40 is mounted such that it can rotate about a fixed-position shaft 20. This tripping lever is of approximately L-shaped design, with its first arm having a joint head with an eyelet-like opening at its free end, by way of which eyelet-like opening it is mounted on the fixed-position shaft 20 such that it can rotate. Its second arm 43 is integrally formed approximately at right angles on the first arm. The first arm has a latching surface approximately in its centre.

The tripping lever 40 is added to the unit formed by coupling the switching toggle 19, the intermediate lever 33 and the catch lever 37 by means of the clip 27.

The catch lever 37 is fitted at one of its free ends with a tab which, together with the latching surface on the tripping lever 40, forms the latching point for the switching lock when the tripping lever 40 is in the latched position. The tripping lever 40 is pivoted in the clockwise direction towards the catch lever 37 in the latched position.

A prestressed spring arrangement acts on the tripping lever 40 in the direction of its latched position, and holds it firmly in the latched position without any opposing force acting on it.

The tripping lever 40, the switching toggle 19, the intermediate lever 33 and the catch lever 37 therefore form an integral unit which can be prefabricated and is also referred to in the following text as the joint chain. The joint chain can be prefabricated and initially tested as a separate unit.

The intermediate lever 33 has a recess 60 at its end which is averted from the clip 27. It is connected in an articulated manner to the contact lever 62 adjacent to this recess by means of a cylindrical pin 61.

The contact lever 62 is a double-armed lever and is mounted such that it can rotate in an elongate hole 66 on a shaft 63 which is connected in a fixed position to the first housing half-shell 11, so that a first lever element 64 points in the direction of the front wall 12 from the fixed-position shaft 63, and a second lever element 65 points in the direction of the fastening side 16 of the housing from the fixed-position shaft 63. At its free end, the first lever element 64 is fitted with the pin 61, which is connected to it in an interlocking manner. The pin 61 therefore forms the coupling point between the joint chain and the contact lever 62.

The first lever element 64 has a U-shaped contour with a receiving area which is formed by the limbs, which run approximately parallel to the broad sides of the housing, and opens in the direction of the side wall 15, and one of whose limbs has a recess, so that the receiving area is accessible from the broad side of the removed housing half-shell, when the housing is open.

The free end of the second lever element 65 is fitted with the moving contact piece 68.

In the disconnected position illustrated in FIG. 1, a contact compression spring 69, one end of which is supported on the side wall 15 of the housing and a second end of which is supported in the receiving area of the first lever element 64, presses the contact lever 62 in the clockwise direction about the fixed-position shaft 63, so that the moving contact piece 68 is pushed away from the fixed contact piece 70. During this process, the movement path of the contact lever 62 is limited by a stop 71 which is connected in a fixed position to the first housing half-shell, in other words the contact lever 62 rests on the fixed-position stop 71 in the disconnected position. The fixed-position stop 71 is formed by a bolt which is integrally connected to the housing half-shell and, for example, can be produced together with the housing half-shells in an injection-moulding process.

The said figure also shows the coil 72 of the magnetic tripping device 73 and a strip 74 in the form of a thermal bimetallic strip or composed of shape memory alloy as part of the thermal tripping device. In the arrangement as shown in FIG. 1, the contact lever 62 and the contact point which is formed from the moving and the fixed contact piece 68, 70 are located between the magnetic tripping device 73 and the thermal tripping device 75. In other words, the magnetic tripping device 73 and the thermal tripping device 75 are located on different sides of an imaginary plane which runs through the contact lever 62 and is at right angles to the first housing half-shell 11.

On tripping, the magnetic tripping device 73 or the thermal tripping device should open the latching point which is formed by the tab on the catch lever 37 and the latching surface on the tripping lever 40, so that the switching lock is unlatched in this way and the contact lever 62 can be moved by the contact compression spring 69 to the disconnected position illustrated in FIG. 1. To this end, the magnetic tripping device and the thermal tripping device must be mechanically coupled to the tripping lever 40. In the embodiment of the present invention as illustrated in FIG. 1, the mechanical coupling between the magnetic tripping device 73 and the tripping lever 40, and between the thermal tripping device and the tripping lever 40, is provided by means of a striking lever 77 which is mounted in a fixed position such that it can rotate.

To this end, a striking lever 77 in the form of a double-armed lever is mounted such that it can pivot on a further shaft 76, which is connected in a fixed position to the housing half-shell 11.

A first arm element 78 of the striking lever 77 points from the fixed-position shaft 76 in the direction of the fastening side 16 of the housing. It has an opening in which a first limb of a transmission clip 80 is held such that it can move.

The second limb of the transmission clip 80 is guided such that it can move in a guide groove 81 in the housing. The side walls 82 of the guide groove 81 are in this case made sufficiently deep and the second limb of the transmission clip 80 is correspondingly designed to be sufficiently long that the strip 74 of the thermal tripping device can move over the side walls of the guide groove 81 when it is bent, on heating, in the anticlockwise direction, and in the process carries along the transmission clip 80 by way of its second limb.

By means of the tensile force, the transmission clip 80 pivots the striking lever 77 in the clockwise direction, and as a result its second arm element 83 acts on the tripping lever 40 such that it is pivoted against the force of the spring arrangement and in the anticlockwise direction, so that the latching surface moves away from the tab and therefore the latching point is unlatched.

A corresponding situation occurs in the event of magnetic tripping. When a short-circuit current occurs, a striking pin which is driven by the armature of the magnetic tripping device emerges from an opening at that end side of the magnetic tripping device 73 which faces the striking lever 77, and strikes the first arm element 78 of the striking lever 77. Since it is struck from right to left, it also pivots the striking lever 76 in the clockwise direction, so that the latching point is unlatched.

The striking lever 76 also has a tab 84 which projects in the direction of the second lever element 65 of the contact lever 62. When the striking pin now pivots the striking lever 77 in the clockwise direction on magnetic tripping, the tab 84 strikes the contact lever 62 once the latching point has been unlatched, and knocks it into the disconnected position shown in FIG. 1. During this process, the moving contact piece 68 is torn away from the fixed contact piece 70, this producing an arc which is quenched in the arc quenching device, which in this case is annotated with the reference number 85 in the figures. In a known manner, the arc quenching device comprises an arc splitter stack 22 with a prechamber area 23 which is bounded by prechamber covering panels 24 parallel to the housing broad sides, and towards which the arc is guided by means of two arc guide rails 25, 26.

The striking movement of the contact lever 62 is limited by the fixed-position stop 71 in this case.

The advantage of using the fixed-position stop 71 for limiting is that the shock force which is transmitted from the striking pin to the contact lever 62 is absorbed by the housing and not by parts of the switching lock. Excessive mechanical loads on the switching lock parts are avoided as a result, so that load-related distortion and movement of the switching lock parts are likewise avoided and the mutual arrangement and position of the individual parts of the switching lock within the tight tolerance limits that are required for reliable functioning are maintained. In particular, this ensures that the contact opening movement can be defined and can be set accurately, and does not change over the course of time owing to mechanical distortion.

The direction of longitudinal extent of the striking lever 77 lies approximately on an imaginary plane which is at right angles to the housing half-shell 11 and runs through the contact point which is formed from the moving and the fixed contact piece 68, 70. This makes it possible to provide a very compact and space-saving mutual arrangement for the assembly elements comprising the switching lock, the magnetic tripping device, the thermal tripping device, and the contact lever with the contact point.

The switching lock, the contact lever 62 with the contact point, the thermal tripping device and the striking lever 77, that is to say virtually all of the mechanically moving parts, are arranged jointly in a first half-area of the housing, which extends from an imaginary centre plane, which runs at right angles to the housing broad sides through the centre point of the shaft 20 of the switching toggle 19, to a narrow side 15 of the housing. The arc quenching device 85 and the magnetic tripping device 73 are accommodated in the other half-area of the housing, which half-area extends from the imaginary centre plane to the opposite narrow side 14 of the housing.

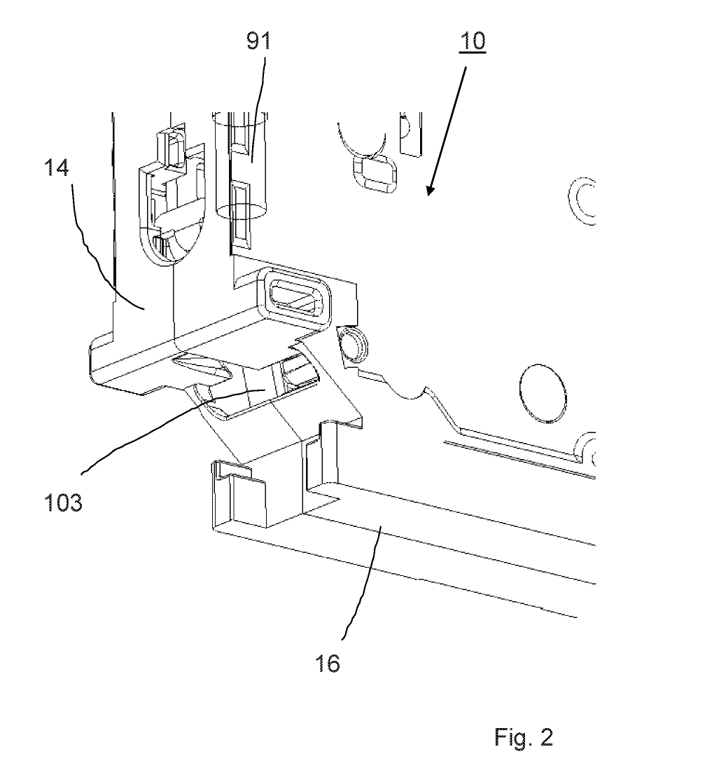

FIG. 2 shows, in a perspective view of the outside of the line circuit breaker 10 in the region of the exhaust air opening 103, the position of this exhaust air opening 103 in a stepped portion which is formed in the region in which the side wall 14 and the fastening side 16 meet.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

| | |
|---|---|
| 10 | Line circuit breaker |
| 10a | Line circuit breaker |
| 10b | Line circuit breaker |
| 11 | First housing half-shell |
| 12 | Front wall |
| 14, 14a, 14b | Side wall |
| 15, 15a, 15b | Side wall |
| 16 | Fastening side |
| 18 | Switching handle |
| 19 | Switching toggle |
| 20 | Fixed-position shaft |
| 21 | Projection |
| 22 | Arc splitter stack |
| 23 | Prechamber area |
| 24 | Prechamber panel |
| 25 | Arc guide rail |
| 26 | Arc guide rail |
| 27 | U-shaped clip |
| 28 | Striking pin |
| 33 | Intermediate lever |
| 36 | Elongate hole in the catch lever |
| 37 | Catch lever |
| 38 | Peg |
| 40 | Tripping lever |
| 43 | Second arm of the tripping lever |
| 60 | Recess at the end of the intermediate lever |
| 61 | Cylindrical pin |
| 62 | Contact lever |
| 63 | Fixed-position shaft |
| 64 | First lever element |
| 65 | Second lever element |
| 68 | Moving contact piece |
| 69 | Contact spring |
| 70 | Fixed contact piece |
| 71 | Stop |
| 72 | Coil |
| 73 | Magnetic tripping device |
| 74 | Thermal bimetallic strip |
| 76 | Shaft of the striking lever |
| 77 | Striking lever |
| 78 | First arm element of the striking lever |
| 80 | Transmission clip |
| 81 | Guide groove |
| 83 | Second arm element of the striking lever |
| 84 | Tab on the striking lever |
| 85 | Arc quenching device |
| 90, 90a, 90b | First connection terminal, plug-in terminal |
| 91, 91a, 91b | Second connection terminal |
| 92 | First operative connection line |
| 93 | Switching mechanism |
| 94 | Second operative connection line |
| 95 | Tripped indicator apparatus |
| 96 | Indicator area |
| 97 | Viewing window |
| 98 | Third operative connection line |
| 99 | Splitter stack |
| 100 | Arc inlet side |
| 101, 101a, 101b | Opposite side, exhaust air side |
| 102 | Opening |
| 103, 103a, 103b | Exhaust air opening |
| 104, 104a, 104b | Exhaust air flow |
| 105, 105a, 105b | Blowout channel |
| 106, 106a, 106b | Guide wall |
| 107, 107a, 107b | Guide wall |
| 108 | Upstream part of the blowout channel |
| 109a | Busbar |
| 109b | Busbar |
| 110 | Service distribution board |

What is claimed is:

1. An electrical service switching device, comprising:
a housing in which at least one contact point is arranged, the housing having a first terminal connection area, in which a plug-in terminal is arranged and is configured for connecting the service switching device to a busbar, and a second terminal connection area, in which a screw terminal for the connection of connection conductors is arranged, the first and the second terminal connection area being formed on opposite narrow sides of the housing; and
an arc quenching device associated with the at least one contact point and having an arc inlet side and an exhaust air side at which an exhaust air flow can exit,
wherein the exhaust air side of the arc quenching device is oriented towards the first terminal connection area in the housing interior,
wherein the housing has an exhaust air opening via which the exhaust air flow leaves the housing, and
wherein the exhaust air opening is fitted to a narrow side of the housing, which narrow side is situated opposite the first terminal connection area.

2. The electrical service switching device of claim 1, wherein the exhaust air side issues into a blowout channel which leads the exhaust air flow past the plug-in terminal and the screw terminal to the exhaust air opening.

3. The electrical service switching device of claim 2, wherein the blowout channel (105) is formed at least in sections with guide walls which are integrally formed on the housing wall.

4. The electrical service switching device of claim 1, wherein the arc quenching device comprises an arc splitter stack with splitter plates which are stacked parallel in relation to one another.

5. The electrical service switching device of claim 4, wherein the arc quenching device has, on the exhaust air side, a closure wall with ventilation openings, so that one of the guide walls is at least partially formed by the closure wall in an upstream part of the blowout channel.
